(19) United States
(12) Patent Application Publication
(10) Pub. No.: US 2009/0279057 A1
(43) Pub. Date: Nov. 12, 2009

(54) Independent upper side and lower side drive type double-sided simultaneous exposure system

(75) Inventor: Jong Su Kim, Gyeongi-do (KR)

Correspondence Address: JORDAN AND HAMBURG LLP, 122 EAST 42ND STREET, SUITE 4000, NEW YORK, NY, 10168, US

(73) Assignee: Protec Co., Ltd., Namdong-gu (KR)

(21) Appl. No.: 12/156,064

(22) Filed: May 29, 2008

(30) Foreign Application Priority Data
May 7, 2008 (KR) 2008-42210

(51) Int. Cl. G03B 27/52

(52) U.S. Cl. 355/23

(57) ABSTRACT

A maskless type exposure system using an exposure engine on which a digital micromirror device (DMD) is mounted includes an independent upper and lower side drive type double-sided simultaneous exposure system, in which a flexible object of exposure, including a flexible board, such as a chip-on-film (COF) or a lead frame, is fed in a rolled state, and is simultaneously exposed throughout an exposure pattern thereof on upper and lower sides thereof by independently driving a plurality of exposure engines in x, y and z axial directions in the case where the flexible exposure object has a large area or a restricted exposure region, thereby reducing costs based on minimized defective proportion and maximized productivity.

### BACKGROUND OF THE INVENTION

1. Field of the Invention

The present invention relates, in general, to a maskless type exposure system using an exposure engine on which a digital micromirror device (DMD) is mounted and, more particularly, to an independent upper and lower side drive type double-sided simultaneous exposure system, in which a flexible object of exposure including a flexible board, such as a chip-on-film (COF) or a lead frame, which can be fed in a rolled state, and is simultaneously exposed with an entire exposure pattern thereof on upper and lower sides thereof by independently driving a plurality of exposure engines in x, y and z axial directions in the case of the flexible exposure object has a large area or a restricted exposure region, thereby reducing costs by minimizing a defective proportion and maximizing productivity.

2. Description of the Related Art

Generally, a semiconductor fabricating process includes an exposure process for forming a pattern on a printed board.

This exposure process is classified into two types: a mask type using a mask, and a maskless type not using a mask.

In this exposure process, it is more important than anything else that an exposure system be aligned before exposure in order to minimize the defective proportion of pattern exposure. Thereby, the pattern can be exposed with high precision.

FIG. 1 is a conceptual diagram illustrating the alignment structure of a conventional mask type upper and lower exposure system. In this mask type, exposure is carried out in a manner such that the positions of reference marks 4 of upper and lower masks 3 and 3′ above and below an exposure stage 2 are checked, such that the positions of the upper and lower masks 3 and 3′ are aligned on the basis of the reference marks 4, and such that the light from an UV lamp is applied en masse.

This mask type does not use an exposure engine, so that it can directly conduct exposure after the alignment is completed using the reference marks.

In this mask type, a rigid printed circuit board (PCB), which is categorized according to material, can be exposed on upper and lower faces thereof, but it is difficult to simultaneously expose upper and lower surfaces of a flexible PCB, i.e. a flexible object of exposure including a flexible board, such as a chip-on-film (COF) or a lead frame, using a mask.

This mask-type exposure system is difficult to use for high-resolution exposure when a high-resolution micro circuit pattern is exposed due to increased mask fabrication and management costs.

Thus, in order to solve the problem with the mask-type exposure system, recently, a maskless type exposure system for realizing high resolution capable of obtaining a submicron circuit line width and reducing the number of processes is being developed.

This maskless type exposure system performs exposure in a manner such that a laser beam from a laser direct imaging system is applied to the unit pixel of a discrete exposure engine so as to align the unit pixels of upper and lower exposure engines of an exposure stage.

One example of such a maskless type exposure system is disclosed in Korean Patent Application Publication No. 10-2006-51792.

This maskless type exposure system performs exposure by winding a flexible object of exposure, that is, a flexible board such as a flexible PCB called a COF or a lead frame, around a roll, feeding the flexible exposure object to an exposure section by means of roll feeding, and projecting exposure patterns onto a photosensitive substance (e.g. dry film resist or photoresist) from a plurality of exposure engines disposed above and below the exposure section.

At this time, since the light emitted from the exposure engines cannot expose the entire region of the photosensitive material at one time, part of the entire region of the photosensitive material moves toward the exposure engines, so that the entire region of the photosensitive material is exposed.

In other words, when using this conventional exposure system, one has no choice but to install the plurality of exposure engines corresponding to the patterns to be exposed on the flexible exposure object, and thus the installation of such equipment at an enormous cost cannot be avoided.

Thus, it takes a lot of time to perform the exposure, which leads to low productivity and a high defective proportion.

In particular, the flexible exposure object moves to be exposed by the plurality of exposure engines in a stationary state. As such, in the case where the exposure region becomes wider, the number of exposure engines must be further increased.

In other words, the problems with the above-mentioned convention exposure system are summarized as follows.

First, the number of exposure engines and the exposure region must be increased.

Second, workability is low because exposure is impossible while the flexible exposure object is moving on upper and lower sides thereof in longitudinal and transverse directions at the same time.

Third, in the case in which the flexible exposure object, such as the COF or the lead frame, which is fed in a rolled state, is exposed, the number of exposure engines must be high in order for the entire region to be exposed in an exposure direction as well as in a direction perpendicular thereto. As a result, the volume of the equipment and the associated cost are increased.

### SUMMARY OF THE INVENTION

Accordingly, the present invention has been made keeping in mind the above problems occurring in the related art, and an object of the present invention is to provide an independent upper and lower side drive type double-sided simultaneous exposure system, in which a flexible object of exposure (photosensitive material) including a flexible board, such as a chip-on-film (COF) or a lead frame, which can be fed in a rolled state, is simultaneously exposed on upper and lower sides thereof in a fixed state by independently driving at least one set of exposure engines in x, y and z axial directions, thereby providing an optimal environment to the flexible exposure object, and maximizing exposure workability and productivity.

In order to achieve the above object, according to one aspect of the present invention, there is provided an independent upper and lower side drive type double-sided simultaneous exposure system, which comprises:

a base plate, which feeds a flexible object of exposure in a rolled state on both sides in one direction, and has a flexible exposure object fixing means fixing the flexible exposure object in position at an exposure processing section in the middle thereof; and independent upper and lower drivable exposure modules, which include: upper and lower x-axial movable stages, which are supported above and below the base plate, and are individually driven above and below the flexible exposure object fixing means in a x-axial direction; upper and lower y-axial movable stages, which are supported on the upper and lower x-axial movable stages, and are individually driven above and below the upper and lower x-axial movable stages in a y-axial direction; upper and lower exposing means, which are supported on the upper and lower y-axial movable stages, pass through the middles of the upper and lower y-axial movable stages and the upper and lower x-axial movable stages so as to be able to be elevated in a z-axial direction, and have at least one set of exposure engines; and z-axial driving means, which are installed on the respective upper and lower exposing means, and provide z-axial movement.

Here, the upper and lower x-axial movable stages may be slidably guided on respective linear motion guides disposed therebetween by driving means, and the upper and lower y-axial movable stages may be slidably guided on respective linear motion guides disposed therebetween by driving means.

Further, the z-axial driving means may include servo motors, ball screws elevated by driving the servo motors, and linear motion guides guiding stable elevation of the upper and lower exposing means on opposite sides thereof.

Also, the upper and lower exposing means may include the at least one set of exposure engines, on each of which a digital micromirror device is mounted, installed parallel to each other in quadrilateral boxes, laser displacement sensors measuring an exposure distance from the flexible exposure object to correct an exposure height, and vision cameras checking a correct position of the flexible exposure object.

Meanwhile, the exposure engines may include: collimators, which receive light beams from ultraviolet light sources through optical fibers connected to a control box; beam expander telescopes, which expand the light beams collimated by the collimators into light beams having a desired diameter; cube beam splitters, which split and supply the diameter-adjusted light beams into vertical and horizontal light beams having equal intensity; upper right-angled mirrors, which reflect and cast the vertical light beam split by the cube beam splitters at a right angle in a horizontal direction; upper and lower right-angled mirrors, which reflect and cast the horizontal light beam split by the cube beam splitters at a right angle in a vertical direction, and then reflect and cast the vertical light beam, which has been reflected and cast at a right angle, at a right angle in a horizontal direction. The upper right-angled mirrors may be disposed at an angle of 45° with respect to a plane such that the light beams are incident onto incident sections of the exposure engines disposed at an angle of 45° in the horizontal direction.

Further, the flexible exposure object fixing means may include: an exposure plate; fixing plates, which closely fix the flexible exposure object from top to bottom on left-hand and right-hand sides of the exposure plate; and air cylinders, which are assembled with the fixing plates so as to control elevation of the fixing plates.

According to the present invention, the independent upper and lower side drive type double-sided simultaneous exposure system has the following advantages.

First, the upper and lower exposure engines can expose flexible exposure object such as the COF or the lead frame to form programmed patterns while moving in x, y and z axial directions in the state where the flexible exposure object is fixed at a preset position, so that the exposure system can improve the exposure workability and the resulting productivity.

Second, the flexible exposure object can be more efficiently exposed over a large area using at most two exposure engines, so that the exposure system can be made compact and reduce its manufacturing cost.

Third, the exposure engine can expose the flexible exposure object by controlling its movement in a three-dimensional direction, i.e. in three axial directions, so that the exposure system can be optimal for continuous exposure of the rolled flexible exposure object.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is FIG. 1 is a conceptual diagram illustrating the alignment structure of a conventional mask type upper and lower exposure system;

FIG. 2 is a perspective view illustrating an independent upper and lower side drive type double-sided simultaneous exposure system according to an exemplary embodiment of the present invention;

FIG. 3 is an exploded perspective view illustrating an independent upper and lower side drive type double-sided simultaneous exposure system according to an exemplary embodiment of the present invention;

FIG. 4 is a partial exploded perspective view illustrating an independent upper drivable exposure module according to an exemplary embodiment of the present invention;

FIG. 5 is a partial exploded perspective view illustrating an independent lower drivable exposure module according to an exemplary embodiment of the present invention;

FIG. 6 is a top plan view illustrating an independent upper and lower side drive type double-sided simultaneous exposure system according to an exemplary embodiment of the present invention;

FIG. 7 is a front cross-sectional view illustrating an independent upper and lower side drive type double-sided simultaneous exposure system according to an exemplary embodiment of the present invention;

FIG. 8 is a partial cross-sectional view illustrating an independent upper drivable exposure module according to an exemplary embodiment of the present invention;

FIG. 9 is a partial enlarged view illustrating part F of FIG. 8;

FIG. 10 is a partial cross-sectional view illustrating an independent lower drivable exposure module according to an exemplary embodiment of the present invention;

FIG. 11 is a partial enlarged view illustrating part G of FIG. 10;

FIG. 12 is a partial exploded perspective view illustrating upper (or lower) x-axial and y-axial movable stages according to an exemplary embodiment of the present invention;

FIG. 13 is a partial exploded perspective view illustrating the state in which an upper (or lower) y-axial movable stage, an upper (or lower) exposing means, and a z-axial driving means are coupled with each other according to an exemplary embodiment of the present invention;

FIG. 14 is a partial perspective view illustrating an upper (or lower) z-axial driving means according to an exemplary embodiment of the present invention;

FIG. 15 is a partial exploded perspective view illustrating a base plate and a flexible exposure object fixing means according to an exemplary embodiment of the present invention;

FIG. 16 is a partial exploded perspective view illustrating a flexible exposure object fixing means installed on a base plate according to an exemplary embodiment of the present invention;

FIG. 17 is a perspective view illustrating the configuration of an upper (or lower) exposing means according to an exemplary embodiment of the present invention;

FIG. 18 is a top plan view illustrating the configuration of an upper (or lower) exposing means according to an exemplary embodiment of the present invention;

FIG. 19 is a conceptual view explaining exposure performed by an upper (or lower) exposing means according to an exemplary embodiment of the present invention; and

FIG. 20 is a control block diagram illustrating the control process of an independent upper and lower side drive type double-sided simultaneous exposure system according to an exemplary embodiment of the present invention.

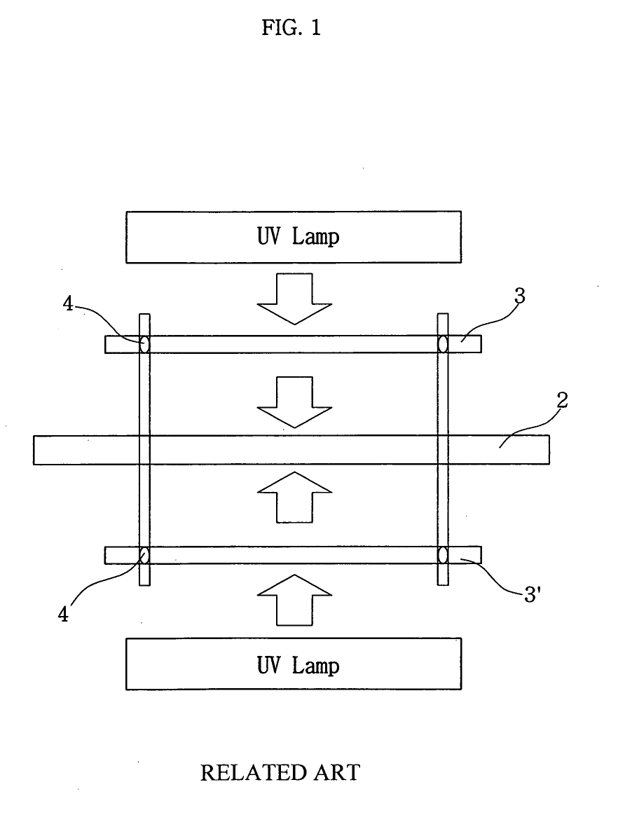

### DETAILED DESCRIPTION OF THE INVENTION

Reference will now be made in greater detail to an exemplary embodiment of the invention, an example of which is illustrated in the accompanying drawings. Wherever possible, the same reference numerals will be used throughout the drawings and the description to refer to the same or like parts.

The present invention is characterized in that independent upper side and lower side exposure sections disposed on upper and lower sides of a base plate are independently controlled to simultaneously expose an object of exposure, such as a flexible board, fed in a rolled state on the upper and lower sides of the base plate.

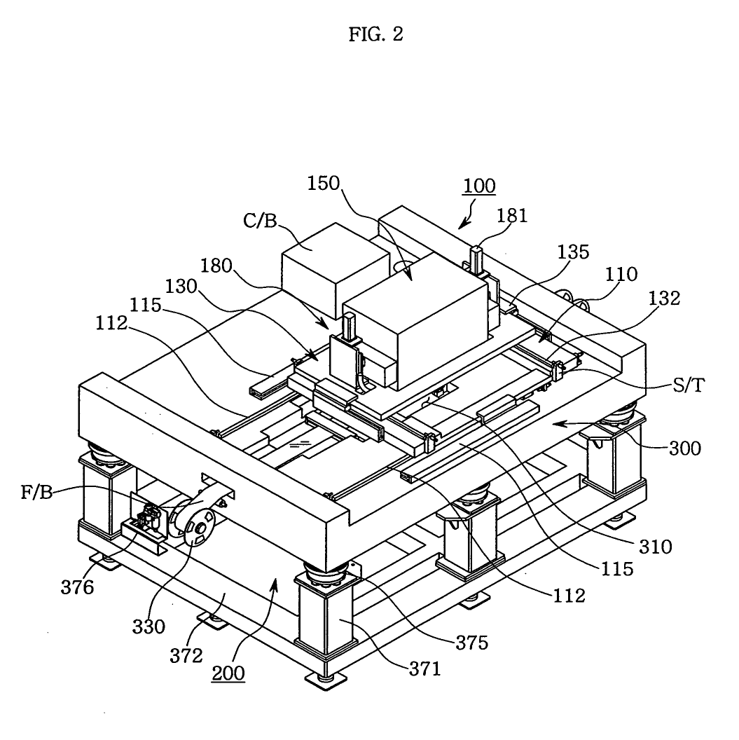

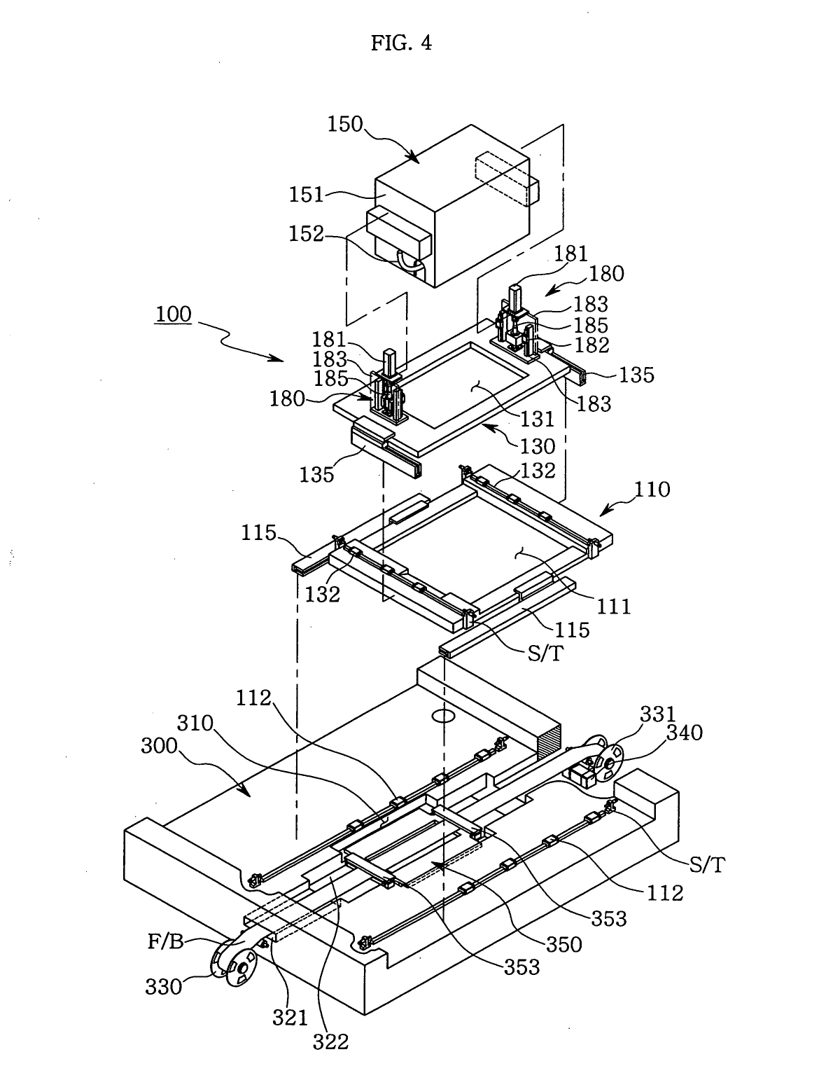

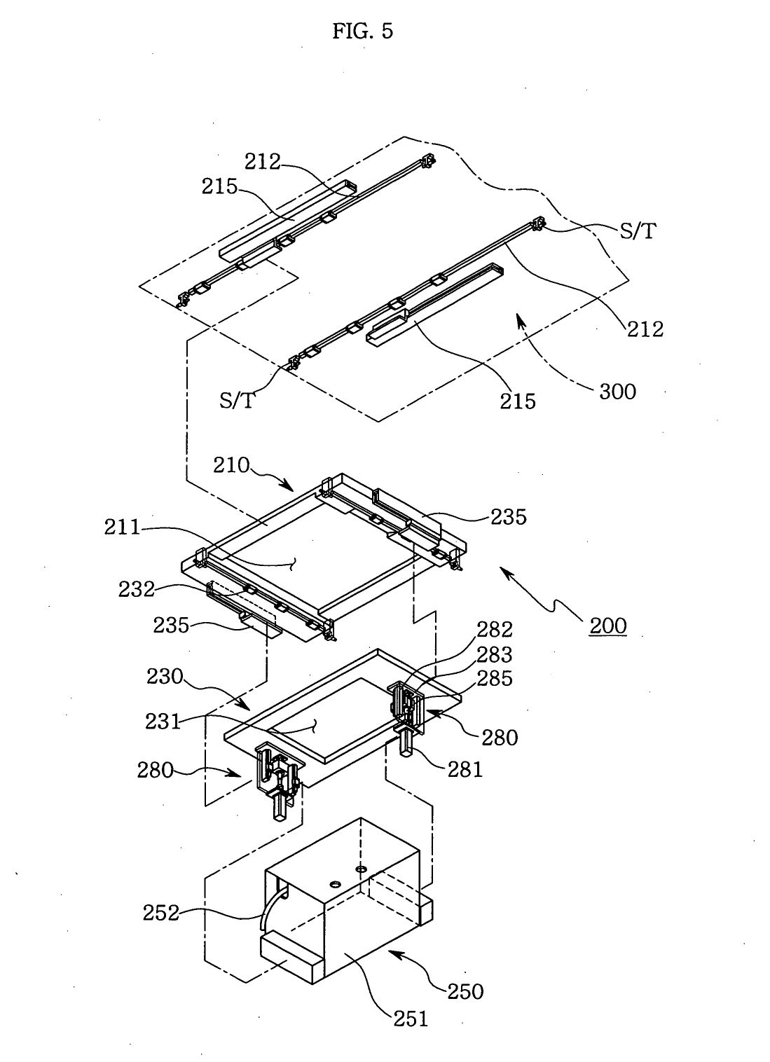

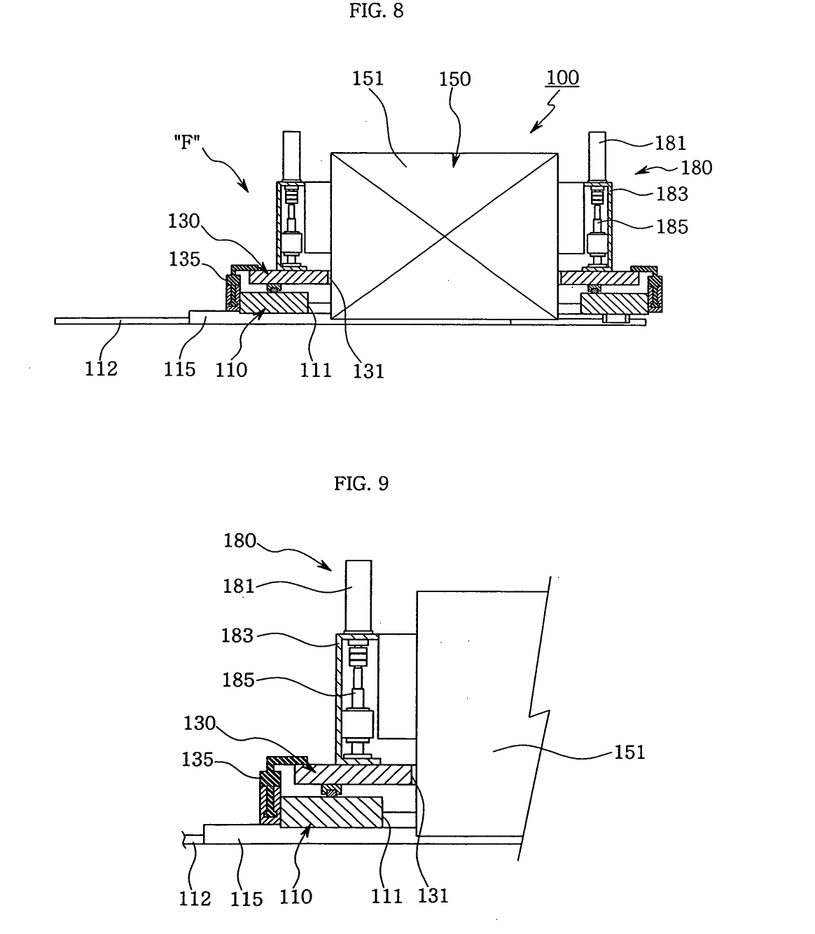

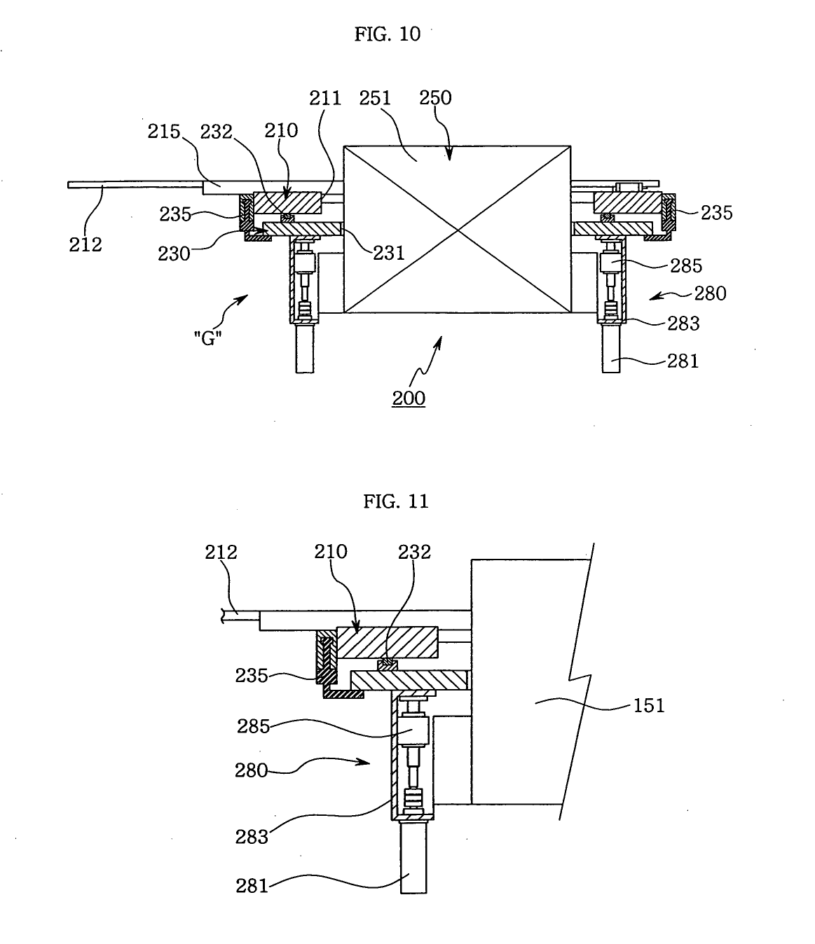

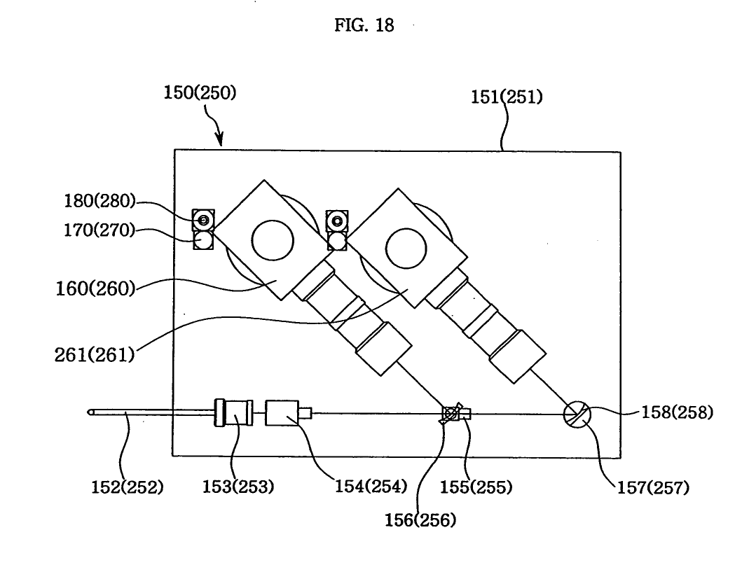

Hereinafter, the exemplary embodiment of the present invention will be described with reference to FIGS. 2 through 20.

The exemplary embodiment of the present invention comprises:

a base plate 300, which feeds a flexible object of exposure such as a flexible board (F/B) in a rolled state on both sides in one direction, and has an F/B fixing means 350 fixing the F/B in position at an exposure processing section 310 in the middle thereof; and

independent upper and lower drivable exposure modules 100 and 200, which include upper and lower x-axial movable stages 110 and 210, which are supported above and below the base plate, and are individually driven above and below the F/B fixing means 350 in a x-axial direction; upper and lower y-axial movable stages 130 and 230, which are supported on the upper and lower x-axial movable stages 110 and 210, and are individually driven above and below the upper and lower x-axial movable stages 110 and 210 in a y-axial direction; upper and lower exposing means 150 and 250, which are supported on the upper and lower y-axial movable stages 130 and 230, pass through the middles of the upper and lower y-axial movable stages 130 and 230 and the upper and lower x-axial movable stages 110 and 210 so as to be able to be elevated in a z-axial direction, and have at least one set of exposure engines 160 and 260 mounted therein; and z-axial driving means 180 and 280, which are installed on the respective upper and lower exposing means 150 and 250, and provide z-axial movement.

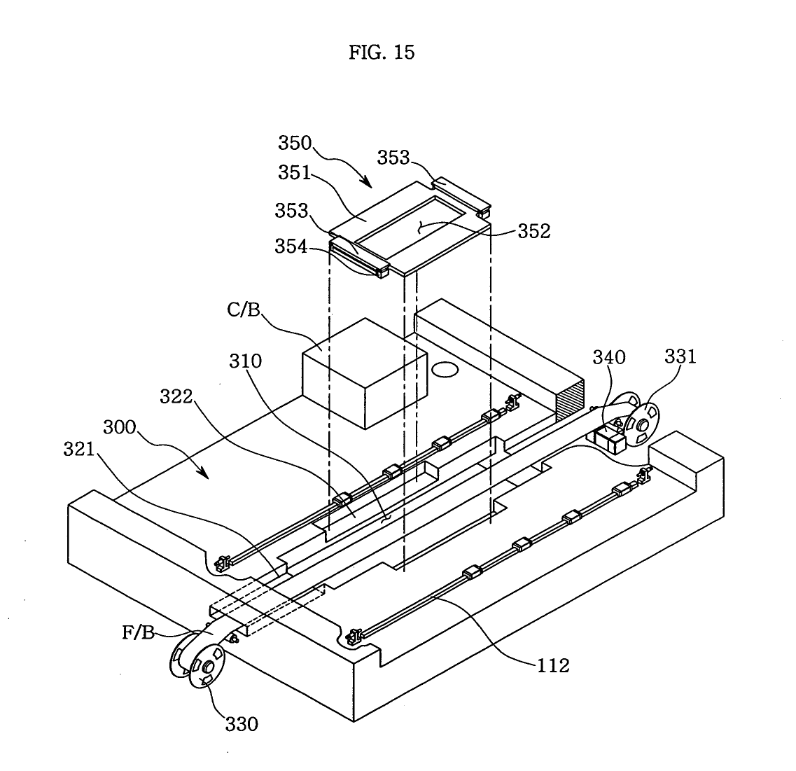

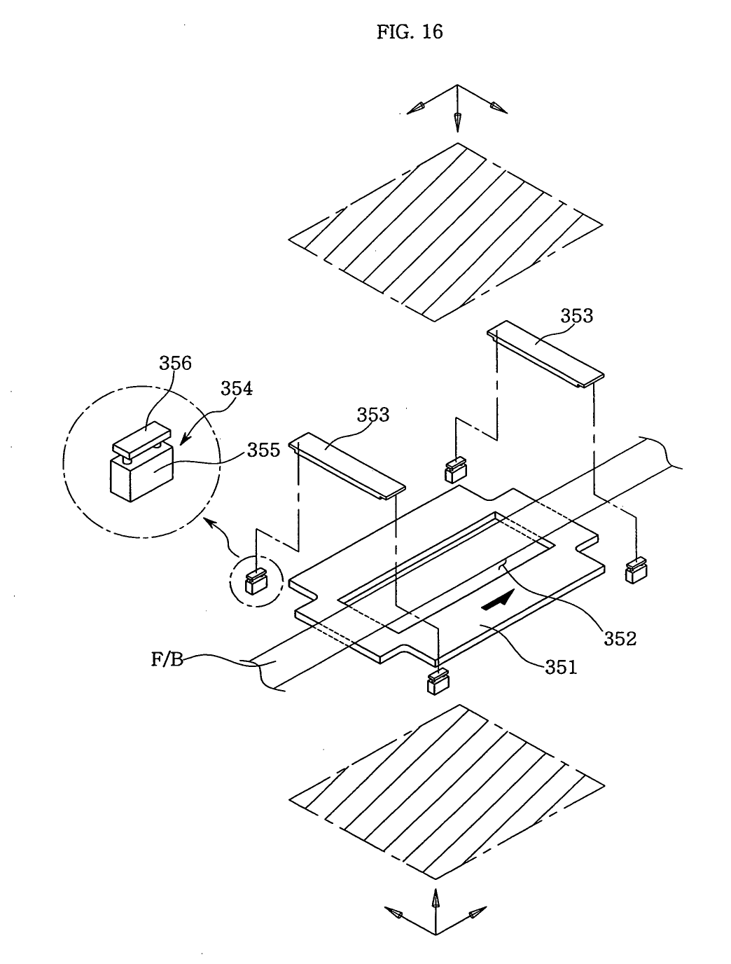

As illustrated in FIG. 15, the base plate 300 is a metal table that has a very smoothly polished surface, and includes a guide channel 321 along which the F/B is guided in leftward and rightward directions, and an exposure processing section 310, which has a through-hole passing through the middle of the guide channel 310 in a vertical direction and steps 322 recessed from the through-hole, and an F/B fixing means 350 assembled to the exposure processing section.

As illustrated in FIG. 16, the F/B fixing means 350 includes: an exposure plate 351, which is fixedly supported on the steps 322 of the base plate 300 and has an exposure hole 352 passing through the middle thereof; a pair of fixing plates 353 and 353 closely fixing the F/B from top to bottom on left-hand and right-hand sides of the exposure plate; and four air cylinders 354, which have bodies 355 fixed to ends of the exposure plates 353 and 353, and rods 356 moving from the respective bodies 355 in expanding and contracting directions and assembled with the fixing plates 353 and 353.

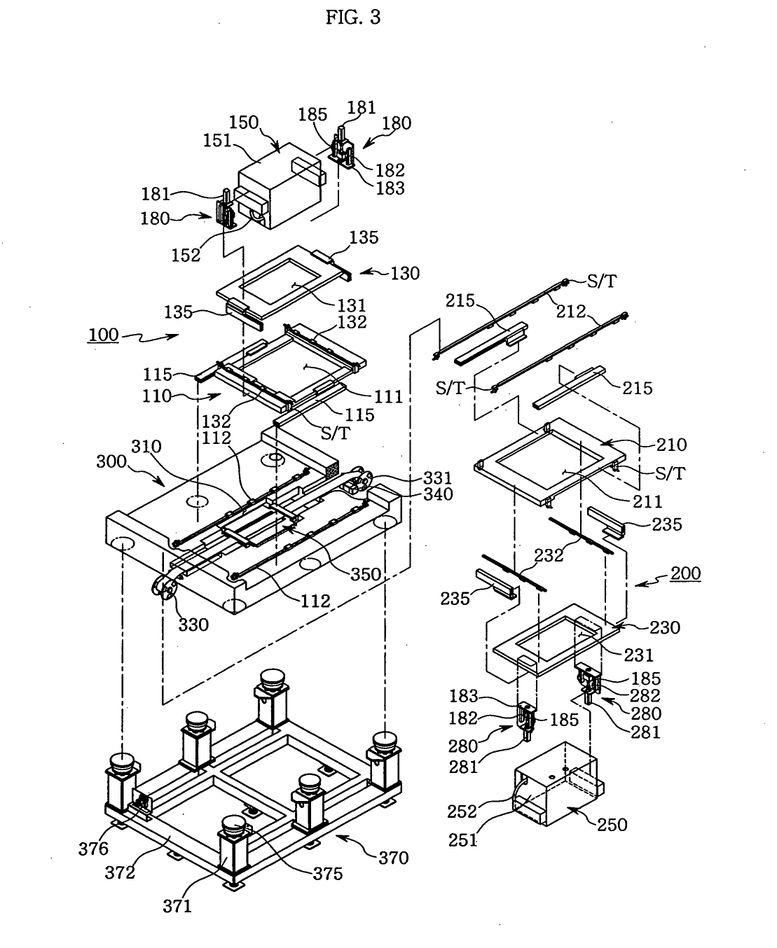

As illustrated in FIG. 3, the base plate 300 is supported at a predetermined height by a base 370, which has a plurality of vertical frames 371 and a horizontal frame 372 supporting these vertical frames 371 thereon and assembled with support legs thereunder.

Here, each vertical frame 371 of the base 370 is assembled with an absorber plate 375 thereon. These absorber plates 375 are disposed along the outer circumference of the lower surface of the base plate 300 at regular intervals, and thus absorb vibrations from the base plate 300.

As illustrated in FIG. 2, each air cylinder 354 of the F/B fixing means 350 is operated by controlling compressed air supplied from an air supply 376 installed on one side of the horizontal frame 372 constituting the base 370. The operation of the air supply 376 is controlled by a control box (C/B) of the base plate 300.

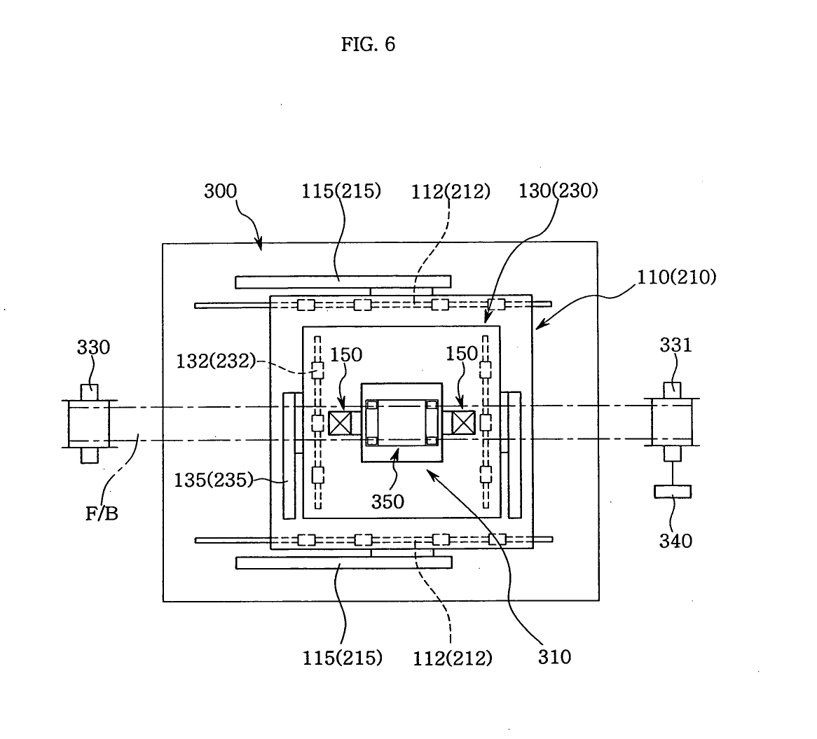

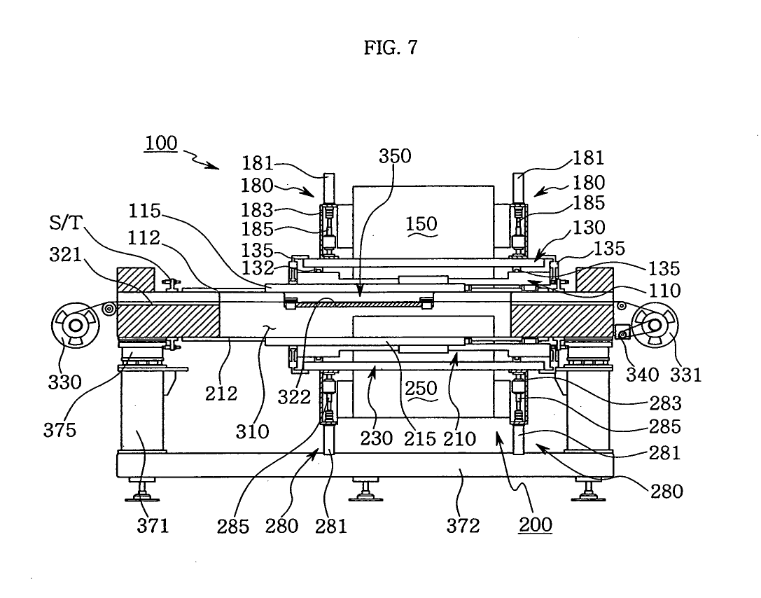

As illustrated in FIGS. 6 and 7, the base plate 300 is equipped with an F/B feeding roll 330 and an F/B recovering roll 331 on the left-hand and right-hand sides thereof. The F/B is fed from the F/B feeding roll 330, is guided between the exposure plate 351 and the fixing plates 353 and 353 of the F/B fixing means 350 through the guide channel 321, and is wound around the F/B recovering roll 331.

At this time, the F/B is fed from left to right a predetermined amount by control of a servo motor 340 driving the F/B recovering roll 331, and thus is partly disposed in the exposure hole 352 of the exposure plate 351. Then, the part of the F/B can be closely fixed on the upper surface of the exposure plate 351 by controlling the F/B fixing means 350, particularly by moving the rods 356 of the air cylinders 354 in a contracting direction, and then the fixing plates 353 and 353 disposed on the rods 356 in a downward direction.

The independent upper and lower drivable exposure modules 100 and 200, which are opposite to each other on the upper and lower sides of the base plate 300, are adapted to simultaneously or individually expose the upper and lower surfaces of the F/B by control of the C/B.

As illustrated in FIGS. 8 through 14, these independent upper and lower drivable exposure modules 100 and 200 are designed so that the upper and lower x-axial movable stages 110 and 210, the upper and lower y-axial movable stages 130 and 230, and the upper and lower exposing means 150 and 250 are sequentially disposed opposite each other, and so that the upper and lower exposing means 150 and 250 are elevated through through-holes 111 and 231, and 211 and 231 formed in the middles of the upper and lower x-axial movable stages 110 and 210 and the upper and lower y-axial movable stages 130 and 230 by the z-axial driving means 180 and 280 coupled with the upper and lower y-axial movable stages 130 and 230.

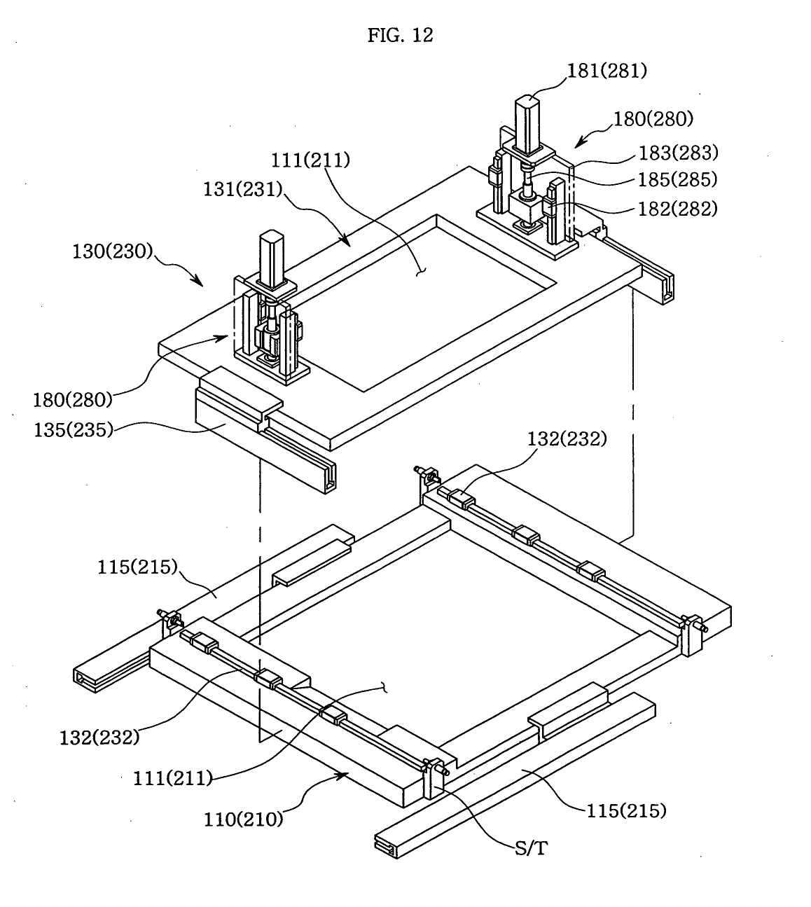

As illustrated in FIG. 12, the upper and lower x-axial movable stages 110 and 210 are guided in leftward and rightward directions (x-axial direction) on upper and lower sides thereof by two pairs of LM guides 112 and 212, in which linear motion (LM) rails coupled to upper and lower sides of the base plate 300 are assembled with LM blocks sliding on the LM rails, and are controlled and moved by two pairs of linear motors 115 and 215 attached to front and rear sides thereof.

The linear motors 115 and 215 are designed so that movers are fixed to front and rear edges of the upper and lower x-axial movable stages 110 and 210, and so that stators supporting the movers are fixed to the base plate 300. Thus, movement distances of the upper and lower x-axial movable stages 110 and 210 are controlled by controlling the movement of the movers.

Of course, the upper x-axial movable stage 110 and the lower x-axial movable stage 210 are individually driven in an x-axial direction according to exposed patterns of the F/B, so that x-axial movement distances of the upper and lower exposing means 150 and 250 are controlled.

The upper and lower y-axial movable stages 130 and 230 are guided in forward and backward directions (y-axial direction) by two pairs of LM guides 132 and 232, in which LM rails coupled to the upper and lower sides of the upper and lower x-axial movable stages 110 and 210 are assembled with LM blocks sliding on the LM rails, and are controlled and moved by two pairs of linear motors 135 and 235 assembled on left-hand and right-hand sides thereof.

The linear motors 135 and 235 are designed so that movers are fixed to left-hand and right-hand edges of the upper and lower y-axial movable stages 130 and 230, and so that stators supporting the movers are fixed to the upper and lower x-axial movable stages 110 and 210. Thus, movement distances of the upper and lower y-axial movable stages 130 and 230 are controlled by controlling movement of the movers.

Of course, the upper y-axial movable stage 130 and the lower y-axial movable stage 230 are individually driven in a y-axial direction according to exposed patterns of the F/B fed in a rolled state, so that forward and backward y-axial movement distances of the upper and lower exposing means 150 and 250 are controlled.

The LM rails of LM guides 112 and 212, and 132 and 232 are provided with stoppers (S/T) on opposite ends thereof, so as to restrict leftward and rightward movement of the upper and lower x-axial movable stages 110 and 210 and forward and backward movement of the upper and lower y-axial movable stages 130 and 230.

The upper and lower exposing means 150 and 250 are adapted to control an elevating distance (z-axial movement distance) through through-holes 111 and 211; and 131 and 231 formed in the middles of the upper and lower x-axial movable stages 110 and 210 and the upper and lower y-axial movable stages 130 and 230 by the two pairs of z-axial driving means 180 and 280 coupled with the upper and lower sides of the upper and lower y-axial movable stages 130 and 230.

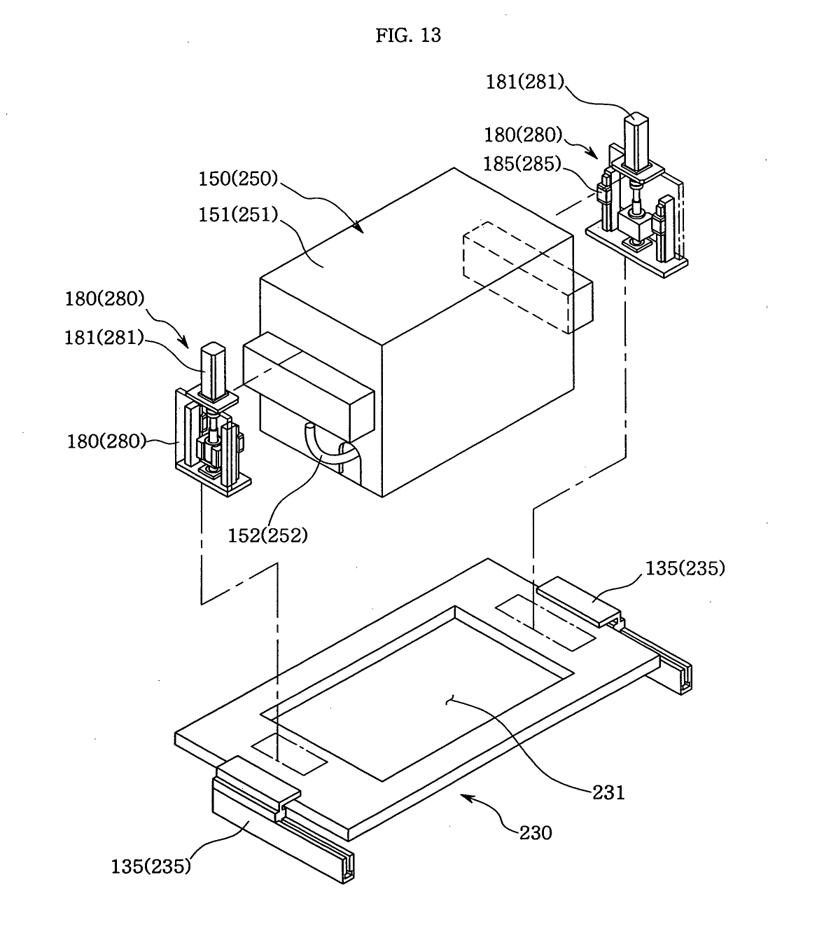

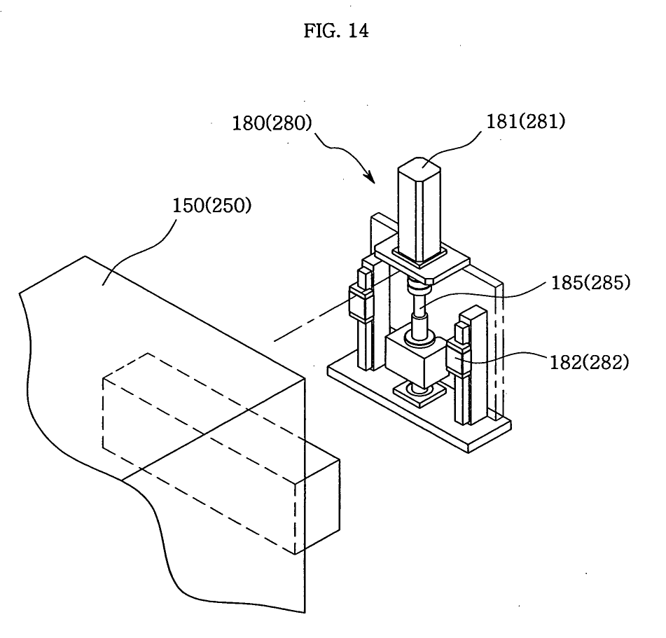

As illustrated in FIGS. 13 and 14, the z-axial driving means 180 and 280 include servo motors 181 and 281, ball screws 185 and 285, elevated by driving the servo motors 181 and 281, and LM guides 182 and 282, guiding stable elevation of the upper and lower exposing means 150 and 250 on opposite sides thereof.

The servo motors 181 and 281 are supported on the upper and lower exposing means 150 and 250 by support brackets 183 and 283. The ball screws 185 and 285 are coupled to driving shafts of the servo motors 181 and 281 at one ends thereof, and are supported on the upper and lower y-axial movable stages 130 and 230 at the other ends thereof. In order to stably guide the elevation of the upper and lower y-axial movable stages, LM rails, fixed to the support brackets 183 and 283, and LM blocks, sliding on the LM rails, are installed on the upper and lower exposing means 150 and 250.

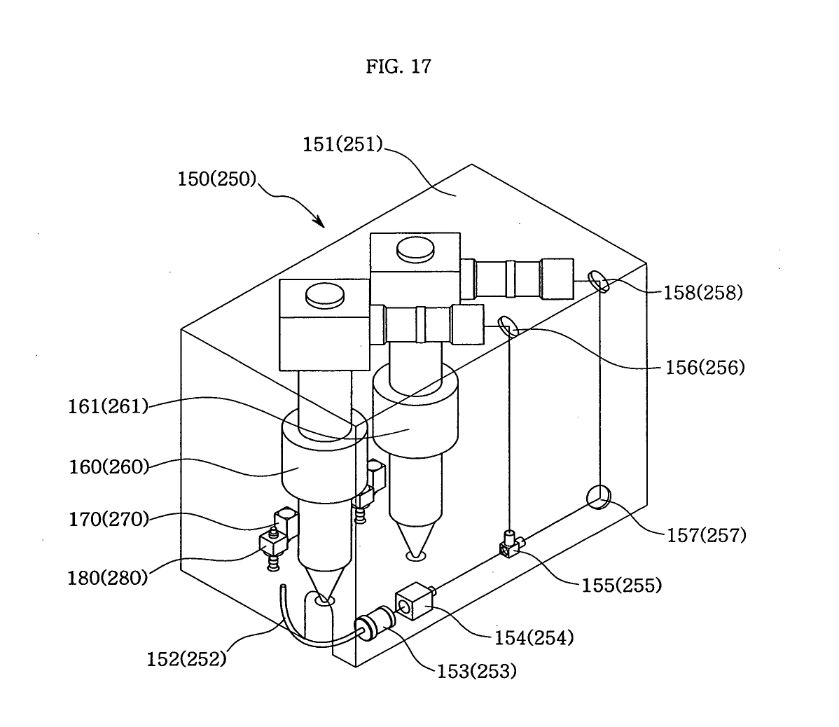

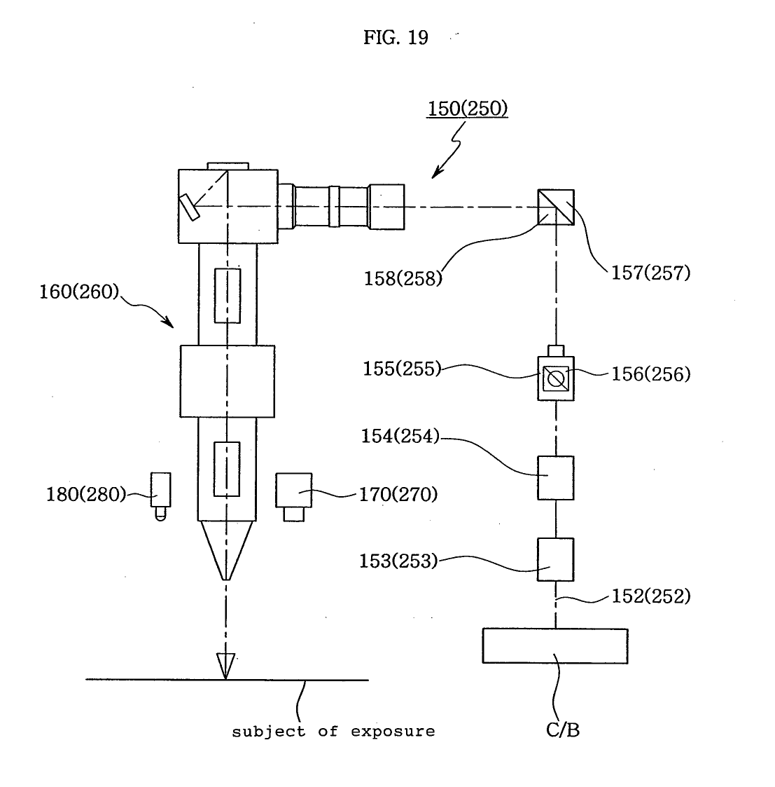

As illustrated in FIGS. 17 and 19, the upper and lower exposing means 150 and 250 include a plurality of exposure engines 160 and 260 in quadrilateral boxes 151 and 251, laser displacement sensors 170 and 270 for measuring the exposure distance from the F/B to correct the exposure height, and vision cameras 180 and 280 for checking the correct position of the F/B.

The vision cameras 180 and 280 function to check whether or not the F/B is fed to the correct position when exposure is performed.

The laser displacement sensors 170 and 270 are sensors, each of which measures the distance from the F/B using a laser and measures the distance between the F/B and each of the exposure engines 160 and 260 to correct the exposure height.

The upper and lower exposing means 150 and 250 are designed so that light beams emitted from UV light sources (having a wavelength of 355 nm or 405 nm) by the C/B are incident onto collimators 153 and 253 through optical fibers 152 and 252, so as to be changed into collimated light beams.

The collimated light beams are expanded into light beams having a desired diameter through beam expander telescopes (BETs) 154 and 254.

Each of the adjusted light beams is split into two light beams, i.e. vertical and horizontal light beams, having the same intensity through cube beam splitters (BSs) 155 and 255.

The vertical and horizontal light beams split with the same intensity are reflected at a predetermined angle through three sets of right-angled mirrors 156 and 256; 157 and 257; and 158 and 258, and are then incident onto the respective sets of exposure engines 160 and 260; and 161 and 261.

More specifically, one of the vertical and horizontal light beams is reflected in a horizontal direction by the upper right-angled mirrors 156 and 256 disposed on upper sides of the cube BSs 155 and 255, and is incident onto one 160 and 260 of the exposure engine sets through incident sections disposed at an angle of 45° when viewed in the traveling direction of the reflected light beam.

The other light beam is incident onto the lower right-angled mirrors 157 and 257 disposed in line with the cube BSs 155 and 255, is reflected in a vertical upward direction, is reflected again in a horizontal direction using the upper right-angled mirrors 158 and 258 disposed in line with the lower right-angled mirrors 157 and 257, and is incident onto the other set of exposure engines 161 and 261 through incident sections disposed at an angle of 45° when viewed in the traveling direction of the reflected light beam.

The plurality of light beams incident onto the respective sets of exposure engines 160 and 260; and 161 and 261 are subjected to on/off modulation through a plurality of digital micromirror devices (DMDs), and the on/off modulated light beams (or images) travel to the F/B, such as the COF or the lead frame, through optical systems installed in the exposure engines in upward and downward directions, thereby performing exposure.

In the upper and lower exposing means 150 and 250, the above-mentioned sets of exposure engines 160 and 260; and 161 and 261 can remarkably reduce the volumes of the quadrilateral boxes 151 and 251, and thus can be made compact.

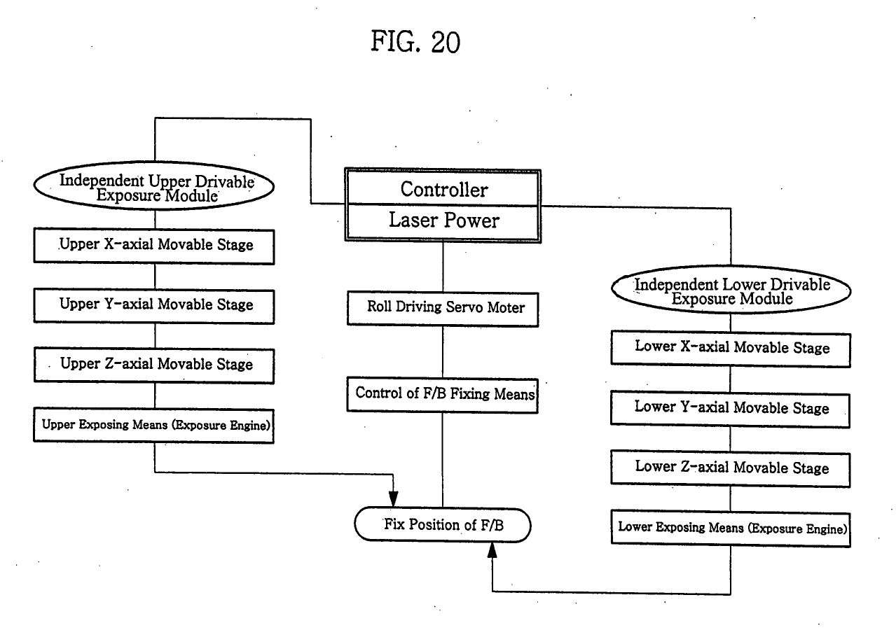

The operation of the present invention configured in this way will be described with reference to FIG. 20, illustrating a control block diagram.

First, a worker sets a flexible object of exposure, that is, an F/B, such as a COF or a lead frame, which is wound around the F/B feeding roll 330 on one side of the base plate 300, on the guide channel 321 by fixing a leading end of the F/B to the F/B recovering roll 331 on the other side of the base plate via the F/B fixing means 350.

In this state, the C/B drives the servo motor 340 to feed the F/B from the F/B feeding roll 330 to the F/B recovering roll 331. Then, the F/B is fixed by the F/B fixing means 350.

In other words, the F/B is fed by a predetermined amount from the left to the right by control of the servo motor 34 driving the F/B recovering roll 311 via a belt, and then is positioned in the exposure hole 352 of the exposure plate 351. Subsequently, the fixing plates 353 and 353 move downwards by means of control of the F/B fixing means 350, particularly by means of operation of the air cylinders 354, thereby closely fixing the F/B on top of the exposure plate 351.

In this state, the independent upper and lower drivable exposure modules 100 and 200 are controlled to expose the upper and lower surfaces of the F/B at the same time.

Of course, if necessary, the upper and lower surfaces of the F/B may be selectively exposed.

This exposure process includes a correcting process of controlling the upper and lower exposing means 150 and 250 constituting the independent upper and lower drivable exposure modules 100 and 200 using the C/B to set an exposure position and an exposure region.

To this end, the upper and lower exposing means 150 and 250 measure the exposure position and height of the F/B using the laser displacement sensors 170 and 270 and the vision cameras 180 and 280, and transmit the measured results to the C/B. The correction process of the upper and lower exposing means 150 and 250 is performed on these measured results.

In detail, the C/B controls the upper and lower x-axial movable stages 110 and 210, the upper and lower y-axial movable stages 130 and 230, and the z-axial driving means 180 and 280 to correct the positions of the exposure engines 160 and 260 of the upper and lower exposing means 150 and 250.

The upper and lower x-axial movable stages 110 and 210 are guided on the respective LM guides 112 and 212 by the linear motors 115 and 215 driven by the C/B, thereby moving along an x axis in leftward and rightward directions.

The upper and lower y-axial movable stages 130 and 230 are guided on the respective LM guides 132 and 232 by the linear motors 135 and 235, thereby moving along a y axis in forward and backward directions.

The upper and lower exposing means 150 and 250 are elevated by a predetermined height by control of the servo motors 181 and 281 of the z-axial driving means 180 and 280.

It should be understood that the above-mentioned control sequence is not always identical, but it is dependent on the positions of the upper and lower exposing means 150 and 250, and is determined by control of the C/B based on the detected values of the laser displacement sensors 170 and 270 and the vision cameras 180 and 280.

In this manner, in the state in which the upper and lower exposing means 150 and 250 are corrected, the upper and lower exposing means 150 and 250 perform exposure throughout the upper and lower surfaces of the F/B in preset patterns using the built-in exposure engines 160 and 260 while simultaneously moving in the x-axial and y-axial directions by means of the C/B.

It will be apparent that the heights of the upper and lower exposing means 150 and 250, particularly the heights of the exposure engines 160 and 260, are adjusted by control of the z-axial driving means 180 and 280 as described above when they need to be adjusted.

In this exposing process of the upper and lower exposing means 150 and 250, light beams emitted from UV light sources (having a wavelength of 355 nm or 405 nm) by control of the C/B are incident onto the collimators 153 and 253 through the optical fibers 152 and 252, and are thereby changed into collimated light beams.

The collimated light beams are expanded into light beams having a desired diameter through the BETs 154 and 254. Each of the adjusted light beams is split into two light beams, i.e. vertical and horizontal light beams, having the same intensity through the cube BSs 155 and 255. Here, one of the vertical and horizontal light beams is reflected in a horizontal direction by the upper right-angled mirrors 156 and 256 disposed above the cube BSs 155 and 255, and is incident onto one set of exposure engines 160 and 260 through incident sections disposed at an angle of 45° when viewed in the traveling direction of the reflected light beam, while the other light beam is incident onto the lower right-angled mirrors 157 and 257 disposed in line with the cube BSs 155 and 255, is reflected in a vertical upward direction, is reflected again in a horizontal direction through the upper right-angled mirrors 158 and 258 disposed in line with the lower right-angled mirrors 157 and 257, and is incident onto the other set of exposure engines 161 and 261 through incident sections disposed at an angle of 45° when viewed in the traveling direction of the reflected light beam.

The plurality of light beams incident onto the respective sets of exposure engines 160 and 260; and 161 and 261 are subjected to on/off modulation through the plurality of DMDs, and the on/off modulated light beams (or images) travel to the F/B, such as the COF or the lead frame, through the optical systems installed in the exposure engines in upward and downward directions, thereby performing exposure.

Thus, the exposure regions of the F/B fixed to the F/B fixing means 350 are independently exposed on the upper and lower sides of the F/B, and then the C/B operates the F/B fixing means 350 to release the fixed state of the F/B.

Simultaneously, the C/B controls the servo motor 340 to rotate the F/B recovering roll 331. Thereby, the F/B is fed from the F/B feeding roll 330, and the unexposed part of the F/B is positioned at the exposure processing section 310. Then, the F/B is fixed by the F/B fixing means 350.

In this state, the above-mentioned processes, including the process of feeding the F/B, such as the COF or the lead frame, in a rolled state, and positioning the part of the F/B at the exposing position, are repeated. Thus, the exposure of the F/B is continuously carried out by feeding, exposing, and recovering processes.

As is apparent from the above description, the independent upper and lower side drive type double-sided simultaneous exposure system according to the present invention can simultaneously expose the flexible exposure object, the F/B, such as the COF or the lead frame, which has a large area or a restricted exposure region, while continuously feeding the F/B in the rolled state.

Although exemplary embodiments of the present invention have been described for illustrative purposes, those skilled in the art will appreciate that various modifications, additions and substitutions are possible, without departing from the scope and spirit of the invention as disclosed in the accompanying claims.

What is claimed is:

1. An independent upper and lower side drive type double-sided simultaneous exposure system, comprising:
a base plate, which feeds a flexible object of exposure in a rolled state on both sides in one direction, and has a flexible exposure object fixing means fixing the flexible exposure object in position at an exposure processing section in a middle thereof; and
independent upper and lower drivable exposure modules, which include:
upper and lower x-axial movable stages, which are supported above and below the base plate, and are individually driven above and below the flexible exposure object fixing means in a x-axial direction;
upper and lower y-axial movable stages, which are supported on the upper and lower x-axial movable stages, and are individually driven above and below the upper and lower x-axial movable stages in a y-axial direction;
upper and lower exposing means, which are supported on the upper and lower y-axial movable stages, pass through middles of the upper and lower y-axial movable stages and the upper and lower x-axial movable stages so as to be able to be elevated in a z-axial direction, and have at least one set of exposure engines; and
z-axial driving means, which are installed on the respective upper and lower exposing means, and provide z-axial movement.

2. The independent upper and lower side drive type double-sided simultaneous exposure system as set forth in claim 1, wherein the upper and lower x-axial movable stages are slidably guided on respective linear motion guides disposed therebetween by driving means, and the upper and lower y-axial movable stages are slidably guided on respective linear motion guides disposed therebetween by driving means.

3. The independent upper and lower side drive type double-sided simultaneous exposure system as set forth in claim 1, wherein the z-axial driving means includes servo motors, ball screws elevated by driving the servo motors, and linear motion guides guiding stable elevation of the upper and lower exposing means on opposite sides thereof.

4. The independent upper and lower side drive type double-sided simultaneous exposure system as set forth in claim 1, wherein the upper and lower exposing means include the at least one set of exposure engines, on each of which a digital micromirror device is mounted, installed parallel to each other in quadrilateral boxes, laser displacement sensors measuring an exposure distance from the flexible exposure object to correct an exposure height, and vision cameras checking a correct position of the flexible exposure object.

5. The independent upper and lower side drive type double-sided simultaneous exposure system as set forth in claim 4, wherein:
the exposure engines include: collimators, which receive light beams from ultraviolet light sources through optical fibers connected to a control box; beam expander telescopes, which expand the light beams collimated by the collimators into light beams having a desired diameter; cube beam splitters, which split and supply the diameter-adjusted light beams into vertical and horizontal light beams having equal intensity; upper right-angled mirrors, which reflect and cast the vertical light beam split by the cube beam splitters at a right angle in a horizontal direction; upper and lower right-angled mirrors, which reflect and cast the horizontal light beam split by the cube beam splitters at a right angle in a vertical direction, and then reflect and cast the vertical light beam, which has been reflected and cast at a right angle, at a right angle in a horizontal direction; and
the upper right-angled mirrors are disposed at an angle of 45° with respect to a plane such that the light beams are incident onto incident sections of the exposure engines disposed at an angle of 45° in the horizontal direction.

6. The independent upper and lower side drive type double-sided simultaneous exposure system as set forth in claim 1, wherein the flexible exposure object fixing means includes: an exposure plate; fixing plates, which closely fix the flexible exposure object from top to bottom on left-hand and right-hand sides of the exposure plate; and air cylinders, which are assembled with the fixing plates so as to control elevation of the fixing plates.
